(19) United States
(12) Patent Application Publication
(10) Pub. No.: US 2011/0049902 A1
(43) Pub. Date: Mar. 3, 2011

(54) Air cooled brushless wind alternator

(76) Inventors: Fred Noah Miekka, Arcadia, CA (US); William R. Conklin, Redwood City, CA (US)

(21) Appl. No.: 12/807,113

(22) Filed: Aug. 28, 2010

Related U.S. Application Data
(60) Provisional application No. 61/275,404, filed on Aug. 28, 2009.

(51) Int. Cl. F03D 9/00

(52) U.S. Cl. 290/55

(57) ABSTRACT

Low cost high output wind alternators are disclosed that may be made by modifying existing windmills. The wind alternators of the present invention are brushless alternators that provide high power output without the need to employ rare earth magnets. The low cost high output wind alternators of the present invention employ one or more rotors of circular cross section having permanent magnets mounted around their periphery. The permanent magnets may be mounted to inner rotor surfaces, outer rotor surfaces or both. Stationary stator electromagnets are mounted close enough to the path of the rotating permanent magnets of the rotor to generate electric power. Electromagnet windings are cooled by allowing some of the air coming through the central portion of the windmill to pass over exposed electromagnet winding surfaces. The air cooled brushless alternators of the present invention may be used to add power generating capabilities to existing windmills.

### CROSS REFERENCE TO RELATED APPLICATIONS

This non-provisional application claims benefit of the provisional application filed on Aug. 28, 2009 having application number U.S. 61/275,404.

### BACKGROUND OF THE INVENTION

1. Field of the Invention

This invention relates to windmills for generating electric power. More particularly this invention relates to air cooled power generating windmills employing brushless permanent magnet alternators. The power generating windmills of the present invention employ one or more rotors of circular cross section such as hoops and cylinders having permanent magnets mounted around the periphery. The permanent magnets may be mounted to inner rotor surfaces, outer rotor surfaces or both. Stationary stator electromagnets are mounted close enough to the path of the rotating permanent magnets of the rotor to generate electric power. Electromagnet windings are cooled by allowing some of the air coming through the central portion of the windmill to pass over exposed electromagnet winding surfaces. More cooling is automatically provided as needed by the greater air velocity during periods of high power generation. The air cooled brushless alternators of the present invention may be used to add power generating capabilities to existing windmills.

2. Description of the Related Art

This invention relates to windmills and more particularly relates to permanent magnet alternators for providing power generating capabilities to windmills. Windmills are devices that extract energy from moving air and convert that energy to rotary motion. This rotary motion can then be used to pump water, run machinery, and generate electricity. Windmills have been in use for centuries where their rotary motion has been used to run machinery for such uses as grinding wheat into flour. Windmills also enjoy a long history of pumping water.

More recently, windmills have been used to generate electric power. Many of these wind generators employ specially designed couplings and gear reduction components to increase the RPM to a sufficient level so that the generator can extract significant power from the rotary motion of the blades. The need to increase the RPM value of the generator beyond the RPM value of the windmill blades arises from the fact that the ratio of impellor diameter to generator rotor diameter is usually quite large and may exceed a 50:1 ratio.

Numerous electric generators and alternators may be employed to extract rotary power from the impellor shaft of windmills and produce electric power. A detailed description of electric generators and alternators will now be given. This description is based on the more thorough and complete description found in U.S. Pat. No. 6,967,417 titled “Variable Winding Generator” awarded to Fred Miekka and Peter Mackie included herein by reference.

Generators use the principal of electromagnetic induction to convert the energy of motion into electricity. If an electric wire is moved through a magnetic field, or conversely if a magnetic field is made to change in the presence of such a conductor, an EMF or voltage will be induced in the conductor. The voltage induced in the conductor is determined by the following factors:
(1) If the conductor is a wire in the form of a coil the greater the number of turns in the coil, the greater will be the EMF.
(2) The faster the conductor moves through the magnetic field the greater the EMF.
(3) The stronger the interacting magnetic field is the greater will be the induced EMF. If the conductor is stationary but the magnetic field changes (such as the case with permanent magnet alternators) the faster the rate of change the greater will be the induced EMF.

When power is required such as for lighting applications, a connection is made between the power producing conductor of the generator and to the device. This causes a current to flow from the generator to the device. Whenever a generator delivers power to some device an associated mechanical drag on the moving parts of the generator results. The more power that is pulled from the generator the greater will be the mechanical requirements needed to keep the generator producing power.

Numerous configurations of generators and alternators may be used with windmills to generate electric power. Included in this list are alternators employing two sets of windings, generators employing two sets of windings, generators employing permanent magnets and one set of windings, and permanent magnet alternators. With alternators employing two sets of windings, the stationary windings (stator windings) are mounted to the housing portion and are used to generate electric power. The rotary windings (rotor windings) are located on the rotor of the alternator and are energized by a direct current electric power source to create a continuous magnetic field. The power is provided to the rotor windings through a set of brushes that make contact with conductive metal rings (commutators). The commutators allow for supplying continuous electric current to the rotating rotor windings thereby maintaining their magnetic field. Generators employing two sets of windings use a similar system that has commutators that are segmented to time the activation of individual windings so that direct current results. With many direct current generators wired in this way power is input to the stator windings and the power generated is produced in the rotary windings. Electric generators may also be configured with permanent magnets attached to the generator housing producing the stator magnetic field thereby eliminating the need to provide input power. Brushes and segmented commutators are still required to provide for a timed output of electric current that is need to produce a direct current output. Brushless alternators are alternators that generate alternating current by employing rotating permanent magnets along with stationary electromagnets. This configuration is advantageous owing to the fact that no input power is required and no brushes or commutator is required. The magnets in the rotor spin past the power producing stationary electromagnets. The windmill generators of the present invention are brushless alternators and therefore have no brushes or commutators and do not require input power. The alternating current power may be used as is or may be rectified by diodes to produce an output of direct current. This output of direct current may then be fed into a capacitor or a battery to produce continuous direct current that is relatively free from voltage ripple.

There are numerous brushless windmill alternators. Many of these employ a set of gears or pulleys that increase the RPM (revolutions per minute) of the alternator rotor. This simple approach provides the needed RPM values of the alternator rotor for producing power from the relatively low RPM of the windmill impellor shaft. While being relatively simple, gear boxes used in these systems require extra moving parts, produce unwanted noise, and reduce mechanical efficiency. Gear boxes may be eliminated from windmills employing permanent magnet alternators by placing the permanent magnets directly onto the impellor itself. This approach is outlined in U.S. Pat. No. 4,720,640 included herein by reference awarded to Bjorn M. S. Anderson and Reinhold H. Ziegler titled Fluid Powered Electrical Generator. U.S. Pat. No. 4,720,640 discloses a fluid powered electrical generator having an impellor rotor rotatively mounted on a central support structure. A toroidal outer support structure surrounds the impellor-rotor including a plurality of circumferentially spaced apart fluid dynamic blades. The outward ends of the blades are connected together by a rotor ring having permanent magnets attached. A second outer ring is fitted with electromagnets that have their pole faces in magnetic coupling proximity to the poles of the permanent magnets in the outer rotor ring of the impellor. The result is a wind generator capable of supplying a high output power requiring no added moving parts to the windmill. While being relatively straight forward, this system has the following drawbacks:
(1) The mass of the permanent magnets on the periphery of the impellor adds considerable inertia to the system.
(2) The mass of the permanent magnets on the periphery of the impellor may generate excessive radial forces during high RPM conditions.
(3) The needed small gap of the permanent magnet poles to the electromagnet pole faces is difficult to produce and maintain (this may prove especially problematic for wind generators having impellors of considerable diameter.
(4) A high degree of structural strength is needed to keep the impellor and electromagnet assembly from vibrating excessively at certain RPM values.
(5) Excessive noise may result from excessive vibration.
(6) The rotor may not start spinning due to cogging effects resulting from the poles of the permanent magnets on the periphery of the impellor being attracted to the electromagnet stator poles.
(7) The large requirement for both permanent magnets and electromagnets adds cost and weight.
(8) The need to produce and maintain a high degree of trueness to impellors.
   Despite these drawbacks, the overall simplicity of the system should result in a reduction of overall maintenance along with the ability to produce large amounts of power without the need to use more expensive and difficult to handle rare earth magnets.

A similar system for a fluid driven generator is disclosed in U.S. Pat. No. 5,696,419 awarded to Thomas G. Rakestraw and Alan E Rakestraw and is incorporated herein by reference. U.S. Pat. No. 5,696,419 discloses A shaftless permanent magnet alternator comprising of a rotor having permanent magnets attached to the periphery along with numerous C shaped electromagnets that straddle the rotor with their poles located within magnetic coupling proximity of the permanent magnets in the rotor. Numerous vanes are attached to the inner surface of the rotor for the purposes of converting fluid motion into rotary power. While being relatively compact in size, and eliminating some of the drawbacks of U.S. Pat. No. 4,720,640, the geometry of the vanes lends itself more toward high pressure low cross sectional fluid flow than to ambient wind. Additionally, the generator configuration disclosed in U.S. Pat. No. 5,696,419 does not provide a means for converting existing windmills into wind generators.

Rare earth magnets are permanent magnets having unusually strong magnetic fields. They are called rare earth magnets because they use rare earth elements like neodymium in their compositions. Because rare earth magnets use expensive materials and expensive processes to produce they tend to be more expensive than other magnets made from materials like ceramic. Employing rare earth magnets in generators presents numerous problems in manufacturing. These problems arise from difficulties in handling these strong magnets. The use of rare earth magnets in generators presents special problems with design and assembly. There is a strong tendency for these magnets to pull strongly at iron core electromagnet pole faces. Cogging effects may also present themselves with the finished rotor making startup of the impellor of the wind generator difficult or even impossible. Additionally, these expensive and difficult to handle rare earth permanent magnets may rapidly lose their magnetic strength with heat. Despite these and other issues, rare earth permanent magnets are attractive candidates for use in windmill generators. One way of alleviating the cogging effects of these strong rare earth permanent magnets is to use coreless electromagnets. Coreless electromagnets are electromagnets that consist of a coil of wire but no iron core. Because coreless electromagnets have no iron in them, they do not suffer from issues of the strong rare earth permanent magnets pulling at them. It is generally understood that power producing electromagnets used in permanent magnet alternators require iron cores to concentrate and direct magnetic flux from the moving permanent magnets. Rare earth permanent magnets may have such intense magnetic fields that certain configurations do not require iron core electromagnets.

One example uses vehicle brake disks for the permanent magnet rotor and coreless electromagnets as the stator. The electromagnet windings consist of coils of wire mounted in a planar configuration on a resin disk between two vehicle brake rotors. The vehicle brake rotors have rare earth magnets fastened to their surface within magnetic coupling proximity of the stationary coreless electromagnet windings on the resin disk. A more thorough description outlining the construction of a complete rare earth windmill alternator using vehicle brake disks may be found at the following web address. WWW.otherpower.com/davesmill.html This particular design is interesting owing to the fact that the entire windmill alternator can be made from readily available parts.

Although simple and straightforward, because of its compact size, coupled with the fact that the stator electromagnet windings have no core and are encased in resin, the above described coreless rare earth permanent magnet brake disk alternator requires the use of rare earth permanent magnets and may suffer from excessive heat build up during times of high power generation.

Despite numerous standard configurations for windmill generators and alternators there remains a need for lightweight permanent magnet windmill alternators that may be made by converting existing windmills, do not require the use of rare earth magnets, and have good heat dissipating properties.

It is an object of this invention to provide a simple low cost method to convert existing windmills into wind alternators.

It is a further object of this invention to provide wind alternators that are light in weight.

It is a further object of this invention to provide wind alternators that are capable of high power output.

It is a further object of this invention to provide wind alternators without brushes.

It is a further object of this invention to provide wind alternators without gear reduction.

It is a further object of this invention to provide wind alternators without the need to employ rare earth magnets.

It is a further object of this invention to provide wind alternators that require minimal maintenance.

It is a further object of this invention to provide wind alternators that do not produce excessive noise.

Finally it is an object of this invention to provide wind alternators that do not overheat during high output conditions.

### SUMMARY OF THE INVENTION

This invention therefore proposes low cost high output permanent magnet alternators that can be attached directly to the impellor shaft portion of windmills. The high output alternators of the present invention employ a rotor consisting of one or more rings or cylinders of permanent magnets in magnetic coupling proximity to one or more stator windings. A portion of the air stream moving through the windmill is directed over the stator windings to provide cooling. The result is an efficient compact power generating windmill capable of high output without overheating.

### BRIEF DESCRIPTION OF THE DRAWINGS

FIG. 1 shows a sectional view of a permanent magnet alternator.

FIG. 2 shows a cross sectional view of a wind generator of the prior art employing a ring of permanent magnets on the periphery of the impellor.

FIG. 3 shows a profile view of a power generating windmill of the present invention employing a single hoop of permanent magnets along with c-core stator electromagnets.

FIG. 4 shows a cross sectional view of an alternator for a power generating windmill of the present invention employing a single hoop having permanent magnets mounted on the outside periphery along with numerous electromagnets configured having their pole faces in an inward radial direction.

FIG. 5 shows a cross sectional view of an alternator for a power generating windmill of the present invention employing a single hoop having permanent magnets mounted on the inside periphery along with numerous electromagnets configured having their pole faces in an outward radial direction.

FIG. 6 shows a cross sectional view of an alternator for a power generating windmill of the present invention employing a single hoop having permanent magnets mounted on both the outside and inside periphery along with one set of electromagnets configured having their pole faces in an inward radial direction and another set of electromagnets configured having their pole faces facing outward in a radial direction.

FIG. 7 shows a power generating windmill of the present invention employing two hoops of permanent magnets mounted on the outside periphery along with numerous c-core electromagnets.

FIG. 8 shows a power generating windmill alternator of the present invention employing a hollow cylinder of permanent magnets on the outside surface along with numerous stator electromagnets.

FIG. 9 shows a power generating windmill of the present invention employing a hoop of permanent magnets along with a small added impellor to aid in cooling of the electromagnet windings.

FIG. 10 shows a power generating windmill of the present invention employing a hollow cylinder of permanent magnets along with a small added impellor to aid in cooling of the electromagnet windings.

FIG. 11 shows a power generating windmill of the present invention employing a hoop of permanent magnets along with an added air scoop to aid in cooling of the electromagnet windings.

### DESCRIPTION OF THE INVENTION

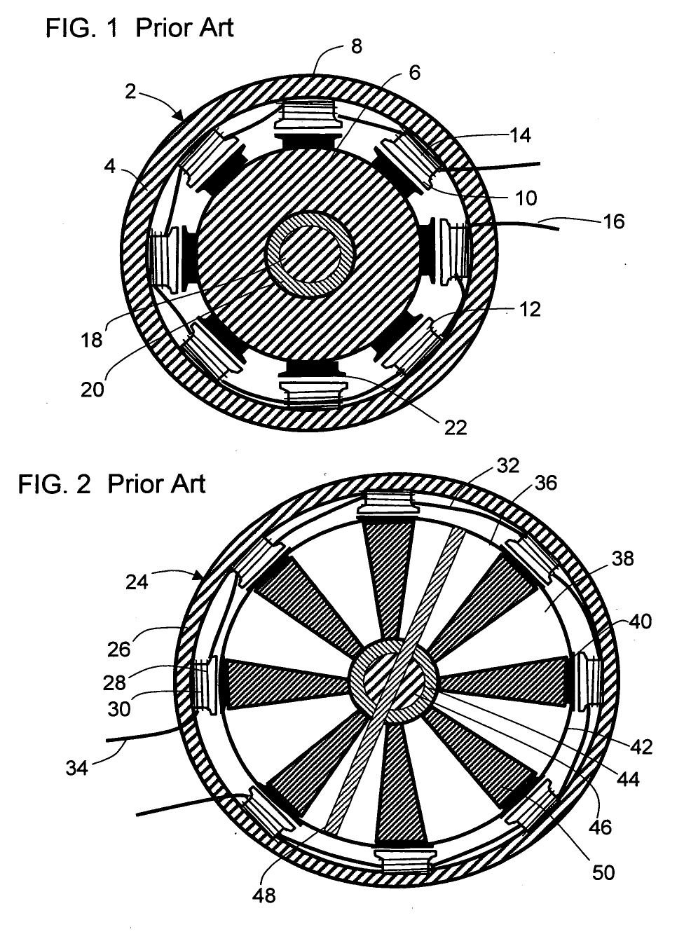

FIG. 1 shows a sectional view of a permanent magnet alternator. Permanent magnet alternator 2 is shown consisting of stator portion 4 and rotor portion 6. Stator portion 4 consists of steel housing portion 8 along with numerous electromagnets 10. Electromagnets 10 along with steel housing portion 8 form a magnetic stator circuit allowing magnetic flux to flow from one electromagnet to the next through steel housing portion 8. Electromagnets 10 consist of core portion 12 and electromagnet windings 14. Also shown are power output wires 16 for tapping electric power generated in electromagnet windings 14 of stator portion 6. Also shown is shaft 18 which is fixedly attached to rotor portion 6. Bearing 20 supports shaft 18 of rotor portion 6 while at the same time allowing shaft 18 and rotor portion 6 to rotate inside of housing portion 8. Also shown are permanent magnets 22. Permanent magnets 22 are shown fixedly attached to rotor portion 6. Rotor portion 6 is made of steel and therefore conducts magnetic flux from one permanent magnet to the next thereby establishing a magnetic circuit. When shaft 18 is rotated inside of housing portion 8, permanent magnets 22 pass by electromagnets 10. Changes in the density and reversal of magnetic flux within the core portions of electromagnets 10 induces alternating current within electromagnet windings 14. Power output wires 16 become energized and can be used to tap alternating current from alternator 2.

FIG. 2 shows a cross sectional view of a wind generator of the prior art employing a ring of permanent magnets on the periphery of the impellor. Windmill generator 24 is shown in accordance with U.S. Pat. No. 4,720,640. Windmill generator 24 is shown consisting of an outer stator portion 26 with numerous electromagnets 28. Also shown are electromagnet windings 30 connected together by connecting wires 32. Output leads 34 are used for delivering A.C. power. Inside of outer stator portion 26 is inner rotor portion 36. Inner rotor portion 36 is shown consisting of turbine portion 38 having numerous permanent magnets 40 mounted on the outside periphery. Also shown is band 42. Band 42 is made of a non-magnetic material and prevents permanent magnets 40 from detaching from turbine portion 38 during rotation.

Turbine portion 38 is shown rotatably attached to outer stator portion 26. Bearing 44 supports shaft 46 of turbine portion 38. Spars 48 support bearing 44 within outer stator portion 26. Also shown are vanes 50. Vanes 50 impart rotational force to turbine portion 38 when acted upon by moving air. Air moving on vanes 50 imparts rotational force to inner rotor portion 36. This causes inner rotor portion 36 to rotate. Rotation of inner rotor portion 36 causes permanent magnets 40 to move past electromagnets 28. This resulting motion energizes electromagnet windings 30. Power generated in electromagnet windings 30 flows through connecting wires 32 to output leads 34.

This particular wind generator configuration has numerous advantages compared with other wind generating systems. The main advantages are realized by the elimination of moving parts. The above described system has only one moving part, the rotor, no brushes to wear out or maintain, and the ability to generate large amounts of power without overheating. This particular system does have some disadvantages. These disadvantages were discovered when a prototype windmill was made and tested. The large number of permanent magnets required around the periphery resulted in the following issues.
1. Increased expense associated with the number of permanent magnets and electromagnets required.
2. Increased weight from the large number of permanent magnets and electromagnets required.
3. Difficulties in balancing the rotor against excessive vibration, severe vibrational harmonics developed at certain speeds.
4. Cogging effects between the permanent magnets and electromagnets prevented the rotor from self starting.
5. High rotational inertia of the rotor having the permanent magnets mounted around the periphery further added to issues of self starting.
6. Difficulties were experienced in maintaining a close gap tolerance between the permanent magnets and the electromagnets. These difficulties resulted from several factors including.
   a. Manufacturing to a tight tolerance was met with difficulty.
   b. Changes in the rotor dimension from thermal expansion and possibly expansion from moisture absorption.
   c. Rotor expansion from high rotational forces during high speed rotation.
7. Excess noise generation.
   It should be noted that large amounts of power could be extracted from the numerous permanent magnets interacting with the large number of electromagnets.

It is to be understood, that FIG. 2 is a simplified drawing of the power generating portion of the wind generating system of U.S. Pat. No. 4,720,640. A more detailed description of this system is given in U.S. Pat. No. 4,720,640.

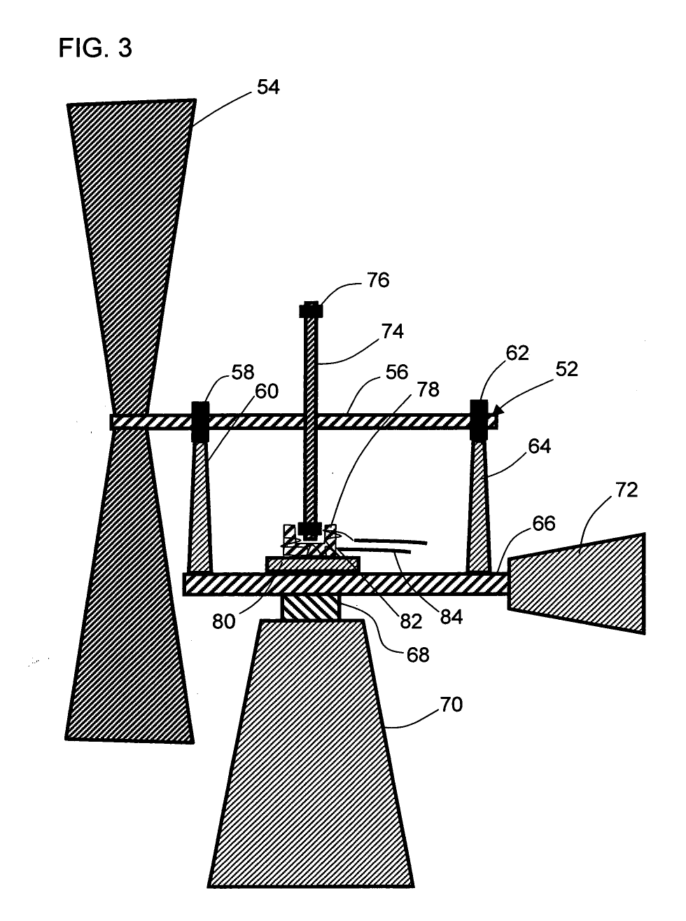

FIG. 3 shows a power generating windmill alternator of the present invention employing a single hoop of permanent magnets along with numerous c-core stator electromagnets. Windmill 52 is shown in complete form. Unlike the windmill generator of FIG. 2, this system uses an ordinary windmill blade, turbine, or propeller to capture energy from moving air. In this way, many of the issues associated with the windmill generator of FIG. 2 are overcome. Additionally, windmill generator 52 can be constructed out of readily available parts and may be used to modify existing windmills into windmill generators. This allows for low cost modification of existing windmills thereby reducing complications involved with constructing windmill generators. In short existing windmills such as aeromotor windmills can be modified with minimal added parts to manufacture windmill generators. Windmill generator 52 is shown in detail. Propeller blade 54 is shown fixedly attached to shaft 56. Front bearing 58 supports the front portion of shaft 56 while at the same time allowing shaft 56 to rotate. Front bearing 58 is mounted into front bearing mount 60 which is secured to windmill base 66. Rear bearing 62 supports the rear portion of shaft 56 and is secured to windmill base 66 with rear bearing mount 64. Windmill base 66 is shown rotatably attached to mount 70 with rear bearing mount 64. Directional fin 72 mounted to windmill base 66 so that windmill base 66 can rotate into the direction of the wind. Also shown is hoop 74. Hoop 74 is shown having permanent magnets mounted around the periphery where maximum velocity occurs. Also shown are one of the electromagnets 78. Electromagnets 78 are positioned so that permanent magnets 76 pass by in magnetic coupling proximity. Also shown is electromagnet mount 80. Electromagnet mount 80 secures electromagnets 78 to windmill base 66. When air moves over propeller blade 54, shaft 56 rotates causing permanent magnets 76 on hoop 74 to pass by electromagnets 78. The resulting changes and reversal of magnetic flux within electromagnets 78 induces A.C. power to be generated in electromagnet windings 82. Electromagnet windings 82 become electrically energized. This electric power can be extracted from power output leads 84 which are in electrical contact with electromagnet windings 82.

The windmill generator of FIG. 3 has the advantages outlined in U.S. Pat. No. 4,720,640 while at the same time eliminating the numerous issues previously mentioned.

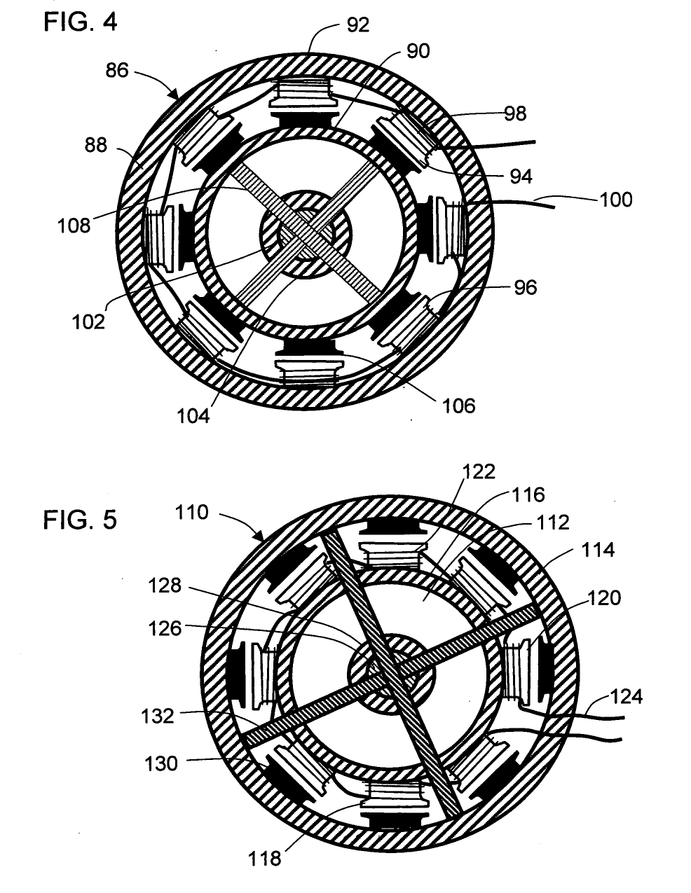

FIG. 4 shows a cross sectional view of an alternator for a power generating windmill of the present invention employing a single hoop having permanent magnets mounted on the outside periphery along with numerous electromagnets configured having their pole faces in an inward radial direction. This particular configuration may be used in the generator portion of the windmill generator of the present invention. Stator portion 88 of alternator 86 consists of steel housing portion 92 along with numerous electromagnets 94. Electromagnets 94 along with steel housing portion 92 form a magnetic stator circuit allowing magnetic flux to flow from one electromagnet to the next through steel housing portion 92. Electromagnets 94 consist of core portion 96 and electromagnet windings 98. Also shown are power output wires 100 for tapping electric power generated in electromagnet windings 98 of stator portion 88. Also shown is shaft 102 which is fixedly attached to a propeller for capturing wind energy (not shown). Shaft 102 is attached to hoop shaped rotor portion 90 with spars 108. Bearing 104 supports shaft 102 of hoop shaped rotor portion 90 while at the same time allowing shaft 102 and hoop shaped rotor portion 90 to rotate inside of housing portion 92. Also shown are permanent magnets 106. Permanent magnets 106 are shown fixedly attached to hoop shaped rotor portion 90. Hoop shaped rotor portion 90 is made of steel and therefore conducts magnetic flux from one permanent magnet to the next thereby establishing a magnetic circuit. When shaft 102 is rotated inside of housing portion 92, permanent magnets 106 pass by electromagnets 94. Changes in the density and reversal of magnetic flux within the core portions of electromagnets 94 induces alternating current within electromagnet windings 98. Power output wires 100 become energized and can be used to tap alternating current from alternator 86.

FIG. 5 shows a power generating windmill of the present invention employing two hoops of permanent magnets along with numerous stator electromagnets. This particular configuration may be used in the generator portion of the windmill generator of the present invention. Stator portion 112 of alternator 110 consists of steel inner portion 116 along with numerous electromagnets 118. Electromagnets 118 along with steel inner portion 116 form a magnetic stator circuit allowing magnetic flux to flow from one electromagnet to the next through steel housing portion 116. Electromagnets 118 consist of core portion 120 and electromagnet windings 122. Also shown are power output wires 124 for tapping electric power generated in electromagnet windings 122 of stator portion 112. Also shown is shaft 126 which is fixedly attached to a propeller for capturing wind energy (not shown). Shaft 126 is attached to hoop shaped rotor portion 114 with spars 132. Bearing 128 supports shaft 126 of hoop shaped rotor portion 114 while at the same time allowing shaft 126 and hoop shaped rotor portion 114 to rotate outside of steel inner portion 116. Also shown are permanent magnets 130. Permanent magnets 130 are shown fixedly attached to hoop shaped rotor portion 114. Hoop shaped rotor portion 114 is made of steel and therefore conducts magnetic flux from one permanent magnet to the next thereby establishing a magnetic circuit. When shaft 126 is rotated outside of steel inner portion 116, permanent magnets 130 pass by electromagnets 118. Changes in the density and reversal of magnetic flux within the core portions of electromagnets 118 induces alternating current within electromagnet windings 122. Power output wires 124 become energized and can be used to tap alternating current from alternator 110.

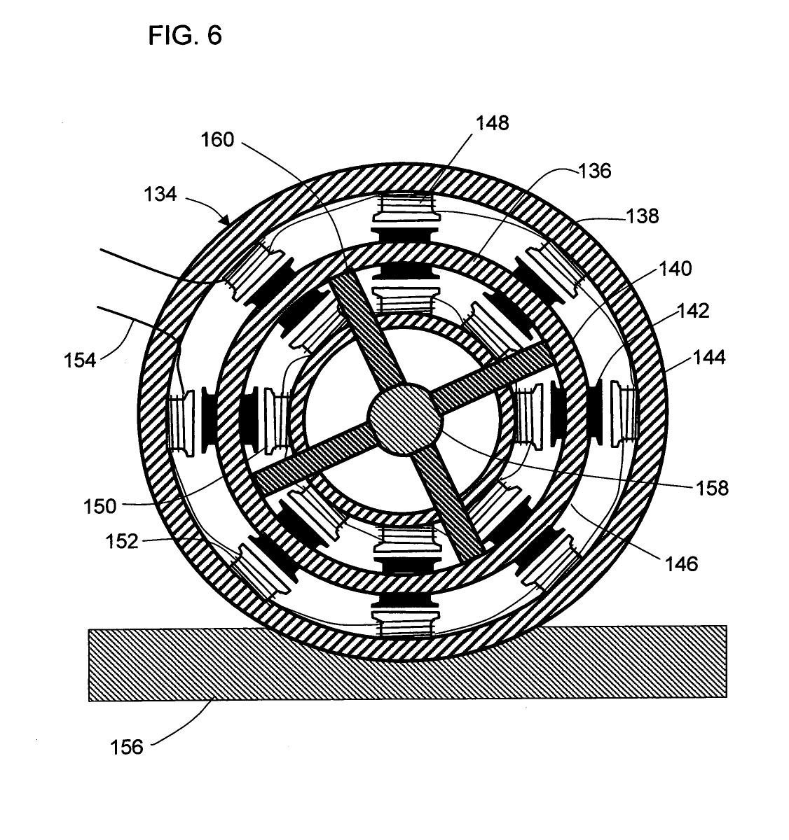

FIG. 6 shows a power generating windmill alternator of the present invention employing a hollow cylinder of permanent magnets along with numerous stator electromagnets. Wind powered alternator 134 consists of rotary portion 136 and stator portion 138. Rotary portion 136 consists of steel hoop portion 140 along with permanent magnets 142 mounted on both the inside periphery of steel hoop portion 140 and the outside periphery of steel hoop portion 140. Stator portion 138 consists of an outer portion 144 and an inner portion 146. Outer portion 144 of stator portion 138 has numerous electromagnets 148 facing inward in a radial direction towards permanent magnets 142 located on the outside periphery of steel hoop portion 140. Inner portion 146 of stator portion 138 has numerous electromagnets 150 facing outward in a radial direction towards permanent magnets 142 located on the inside periphery of steel hoop portion 140. Electromagnet windings 152 are shown on both inner electromagnets 150 and outer electromagnets 148. Electromagnet windings 152 provide electric alternating current power to output leads 154 in the usual way when permanent magnets 142 pass by their pole faces (not shown). Also shown is mount 156 for securing wind powered alternator 134. Also shown is shaft 158 and spars 160 for providing rotary power to rotary portion 136. End bearings (not shown) placed on both ends of shaft 158 hold rotary portion 136 in place while allowing shaft 158 to rotate.

Wind generating alternator 134 takes advantage of generating electric power on both the inner surface and the outer surface of hoop shaped rotors employing permanent magnets thereby enabling relatively small generators to produce significant amounts of electric power during high wind conditions.

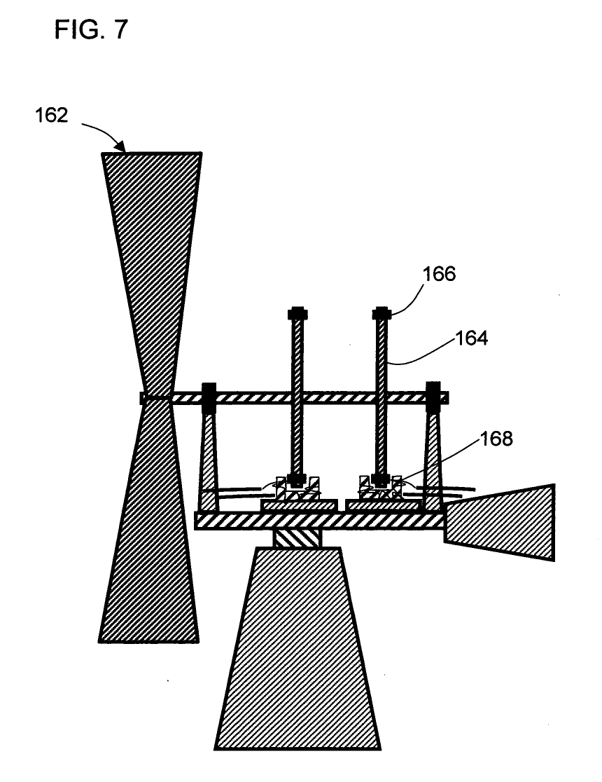

FIG. 7 shows a power generating windmill of the present invention employing two hoops of permanent magnets mounted on the outside periphery along with numerous c-core electromagnets. Power generating windmill 162 is shown having two hoops of permanent magnets and two sets of electromagnets. Power generating windmill 162 is shown identical to the power generating windmill of figure three with an added hoop 164 of permanent magnets 166 along with an added set of power generating electromagnets 168. Although only two hoops of permanent magnets are shown it should be noted that more permanent magnet hoops and sets of electromagnets may be added for increased power generating capacity.

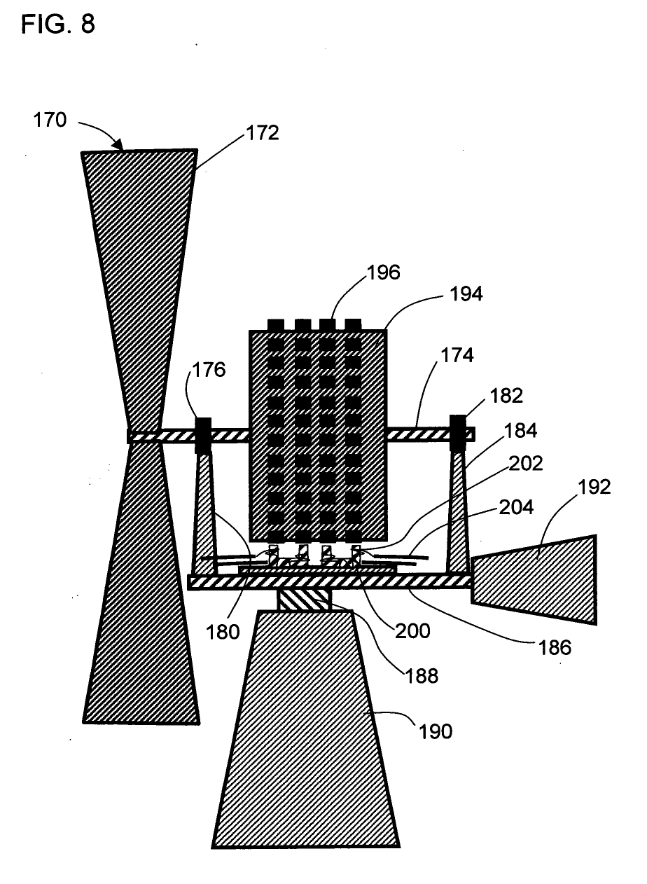

FIG. 8 shows a power generating windmill alternator of the present invention employing a hollow cylinder of permanent magnets on the outside surface along with numerous stator electromagnets. Windmill generator 170 is shown in detail. Propeller blade 172 is shown fixedly attached to shaft 174. Front bearing 176 supports the front portion of shaft 174 while at the same time allowing shaft 174 to rotate. Front bearing 176 is mounted into front bearing mount 180 which is secured to windmill base 186. Rear bearing 182 supports the rear portion of shaft 174 and is secured to windmill base 186 with rear bearing mount 184. Windmill base 186 is shown rotatably attached to mount 190 with rear bearing mount 184. Directional fin 192 mounted to windmill base 186 so that windmill base 186 can rotate into the direction of the wind. Also shown is cylinder 194. Cylinder 194 is shown having permanent magnets mounted around the periphery where maximum velocity occurs. Also shown are one of the electromagnets 198. Electromagnets 198 are positioned so that permanent magnets 196 pass by in magnetic coupling proximity. Also shown is electromagnet mount 200. Electromagnet mount 200 secures electromagnets 198 to windmill base 186. When air moves over propeller blade 172, shaft 174 rotates causing permanent magnets 196 on cylinder 194 to pass by electromagnets 198. The resulting changes and reversal of magnetic flux within electromagnets 198 induces A.C. power to be generated in electromagnet windings 202. Electromagnet windings 202 become electrically energized. This electric power can be extracted from power output leads 204 which are in electrical contact with electromagnet windings 202.

The windmill generator of FIG. 8 has the advantages outlined in U.S. Pat. No. 4,720,640 while at the same time eliminating the numerous issues previously mentioned.

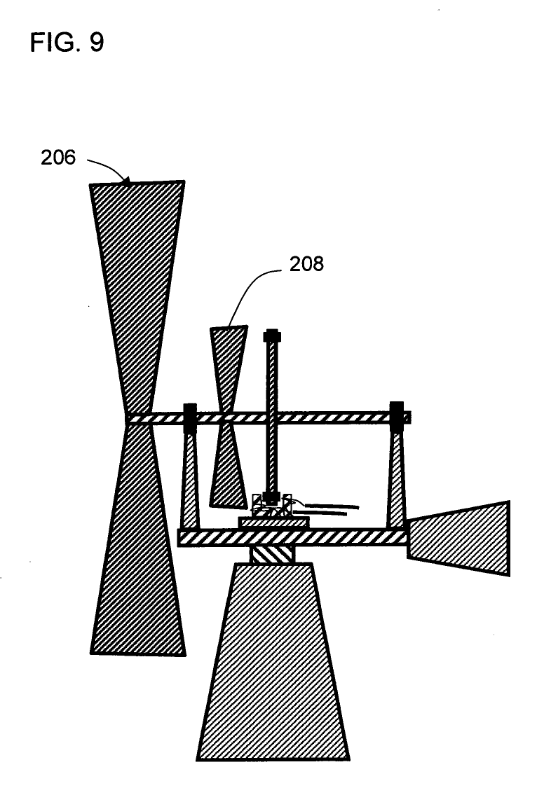

FIG. 9 shows a power generating windmill of the present invention employing a hoop of permanent magnets along with a small added impellor to aid in cooling of the electromagnet windings. Windmill 206 of FIG. 9 is shown identical to windmill 52 of FIG. 3 with the exception of an added impellor 208 for improving the efficiency of cooling of electromagnet windings under high power generating conditions.

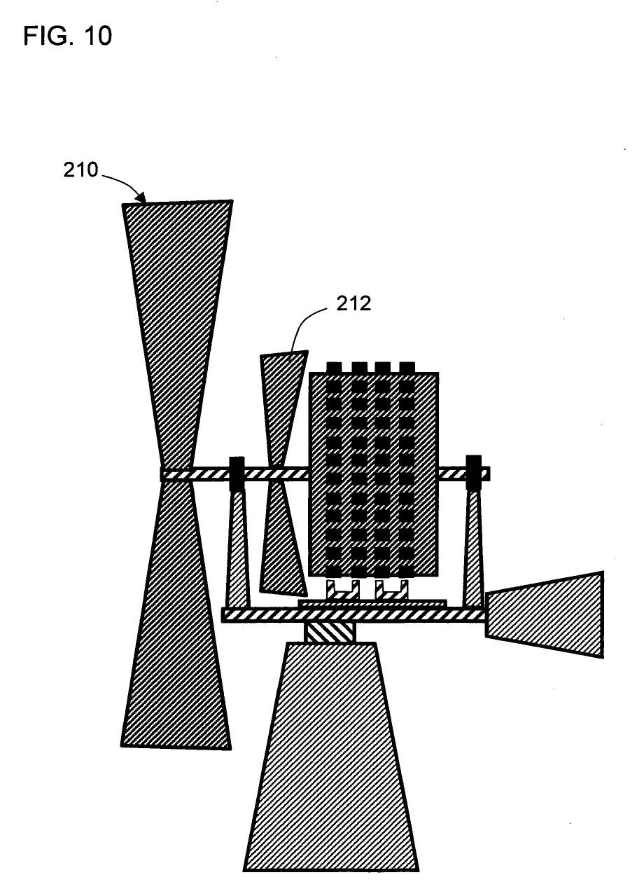

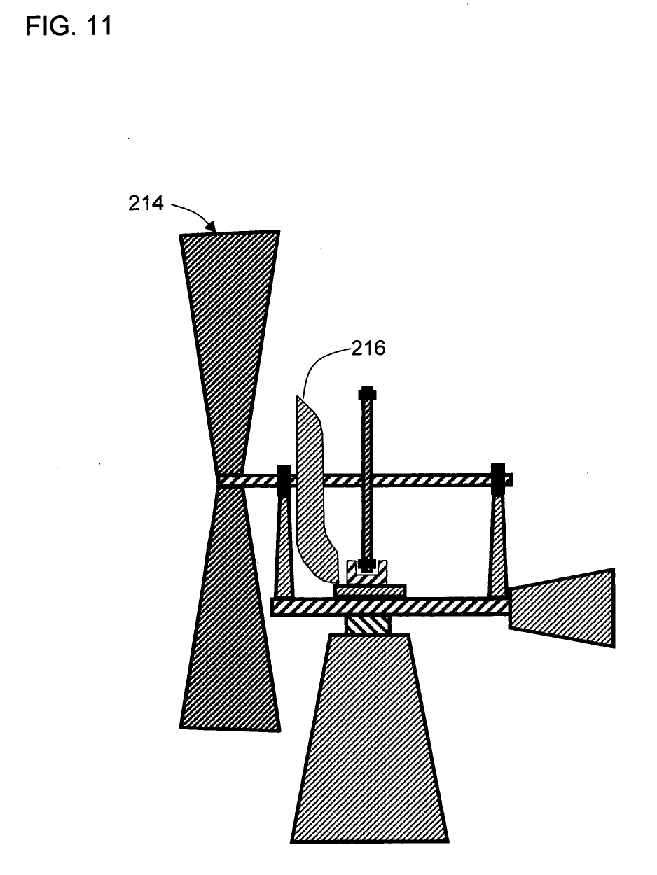

FIG. 10 shows a power generating windmill of the present invention employing a hollow cylinder of permanent magnets along with a small added impellor to aid in cooling of the electromagnet windings. Windmill 210 of FIG. 10 is shown identical to windmill 170 of FIG. 8 with the exception of an added impellor 212 for improving the efficiency of cooling of electromagnet windings under high power generating conditions. Added impellor 212 provides added airflow over the electromagnet windings in order to provide cooling. Another way to improve cooling of electromagnet windings under high power generating conditions is to direct the air stream over the electromagnet windings using cowling. This is illustrated in FIG. 11. It should be noted that the power generating windmills of the present invention may use electromagnets that have their windings somewhat exposed to the outside air. Depending on power output and configuration these power generating windmills may not require the use of added air flow to keep them from overheating.

FIG. 11 shows a power generating windmill of the present invention employing a hoop of permanent magnets along with an added air scoop to aid in cooling of the electromagnet windings. Windmill 214 of FIG. 11 is shown identical to windmill 52 of FIG. 3 with the exception of an added cowling 216 for improving the efficiency of cooling of electromagnet windings under high power generating conditions. Added cowling 216 provides added airflow over the electromagnet windings by concentrating and redirecting air flow in order to provide cooling.

Those skilled in the art will understand that the preceding embodiments of the present invention provide foundation for numerous alternatives and modifications. These other modifications are also within the scope of the limiting technology of the present invention. Accordingly, the present invention is not limited to that precisely shown and described herein but only to that outlined in the appended claims.

What is claimed is:

1. An air cooled brushless wind alternator comprising:
a propeller blade and a shaft;
said propeller blade fixedly attached to said shaft, and
a hoop having a periphery;
said hoop being fixedly attached to said shaft, and
said periphery of said hoop having permanent magnets fixedly attached, and a base;
said base having at least one bearing for rotatably supporting said shaft, and electromagnets;
said electromagnets being fixedly attached to said base in magnetic coupling proximity to said permanent magnets attached to said periphery of said hoop.
